(19) United States
(12) Patent Application Publication
(10) Pub. No.: US 2011/0236124 A1
(43) Pub. Date: Sep. 29, 2011

(54) DEVICE FOR MOUNTING AT LEAST ONE LEVER

(76) Inventors: Hans-Günter Kaiser, Wuppertal (DE); Artur Torka, Hattingen (DE); Stefan Uecker, Ratingen (DE)

(21) Appl. No.: 12/998,803

(22) PCT Filed: Nov. 23, 2009
(86) PCT No.: PCT/EP2009/008421

§ 371 Date: Jun. 2, 2011

(30) Foreign Application Priority Data
Dec. 9, 2008 (JP) 10 2008 061 229.4

(51) Int. Cl. F16C 11/04

(52) U.S. Cl. 403/119

(57) ABSTRACT

The invention relates to a device for mounting at least one lever (20). The device comprising a housing (10), in which the lever (20) can be received at least regionally. Furthermore, a bearing support (30) having a bearing axis (31) is provided, about which the lever (20) is pivotally mounted. The bearing support (30) comprises two bearing elements (21, 11), that is a first bearing element (21) which is rotationally fixed to the lever (20) and a second bearing element (11) which is arranged on the housing (10) in a rotationally fixed manner. According to the invention, the second bearing element (11) is integral with the housing (10). Furthermore, a securing member (40) is provided, which secures both bearing elements (21, 11) in the assembled position thereof. Both bearing elements (21, 11) are only held together by a pure positive engagement taking into consideration the securing member (40).

The invention relates to a device according to the preamble of the claim 1. Such devices are used in many regions, for example in the field of motor car technology. Here such devices are employed in particular with locks for doors and flaps at vehicles.

Usually an external device component, for example an external bearing pin, is employed, which is connected to the housing. In addition the external bearing pin is brought in action connection with the bearing element on the lever side. These devices are however relatively high in cost in their production. In addition, and the additional bearing pins are frequently clipped into the device.

Certain forces are required in association with the assembly of the clip connection in order to overcome the force of the clip and it can occur that the clip becomes damaged prior to or during the mounting. For these reasons, an additional quality control is still necessary after the performance of the assembly in order to determine if the clip connection is in fact realized and the clip was also not damaged. In addition, the production tolerances have to be kept within a narrow region, since otherwise the tolerances could add up in an unfavorable situation during the assembly of the device components housing, external bearing pin, and bearing element on the lever side, which then could lead either to an interfering rattling noise during motions or to a clamping of the device components.

Therefore, it is an object of the present invention to offer a cost favorable and simply producible alternative to the existing lever bearings, which can be simply assembled. This object is attained by the characterizing features of claim 1, which are associated with the following particular importance.

The second bearing element together with the housing forms a single piece. The first and second bearing elements are simply plugged together for the assembly of the bearing. A securing member is furnished additionally, wherein the securing member then secures the two bearing elements in this position. A pure form matching connection therefrom results between the two bearing elements. This form matching connection is particularly sensitive to errors and interferences. The assembly is very much simplified by the simple plugging together of the bearing elements. In addition, no external bearing pin has any longer to be used, which renders the complete device also in the production clearly more cost favorable. Also the additional testing if the assembly had been performed correctly, can be dispensed with.

A cover is furnished for the housing according to a preferred embodiment example, wherein the cover simultaneously also serves as the securing member for the bearing support. Thus the assembly expenditure is further decreased, where the housing cover is furnished at any rate and has to be assembled.

It is particularly advantageous if the housing and/or the cover as well as also if possible the lever or, respectively, one or two of the bearing elements are produced from plastic. This material is particularly cost favorable in the production and it is simply to handle. The plastic injection molding method is in particular recommended in connection with plastic elements, since thereby the individual device components can be produced especially simple. Of course, one or several device components can also consist of metal. In principle it is here the same, which of the device components are produced from plastic and which device components are produced from metal. It is also possible to furnish all elements from plastic or all elements from metal. In case where metal device components are employed, the zinc diecutting method is in particular offered in case of employment of metal device components for their production.

The securing member or, respectively, the housing cover can be brought into action connection with the housing, the bearing or, respectively, one or several bearing elements by any disengageable or nondetachable connection. Therewith are in particular recommended plugs, clips, screwing, riveting, clamping, welding, adhesively attaching, snapping or any other known connection type.

The use of the invention device is particularly advantageous in the region of housings for locks, in particular for locks of doors or flaps of vehicles. In this case the lever can serve for example for actuating the detent pawl of a lock. However also different fields of use of the lever are conceivable, such as the actuating of a switch or calipers or a key button. This can but does not have to find use with levers in lock housings. Further advantages and embodiments of the invention result from the following description, the sub claims and the drawings. The invention is shown in five embodiment examples in the figures. There is shown in:

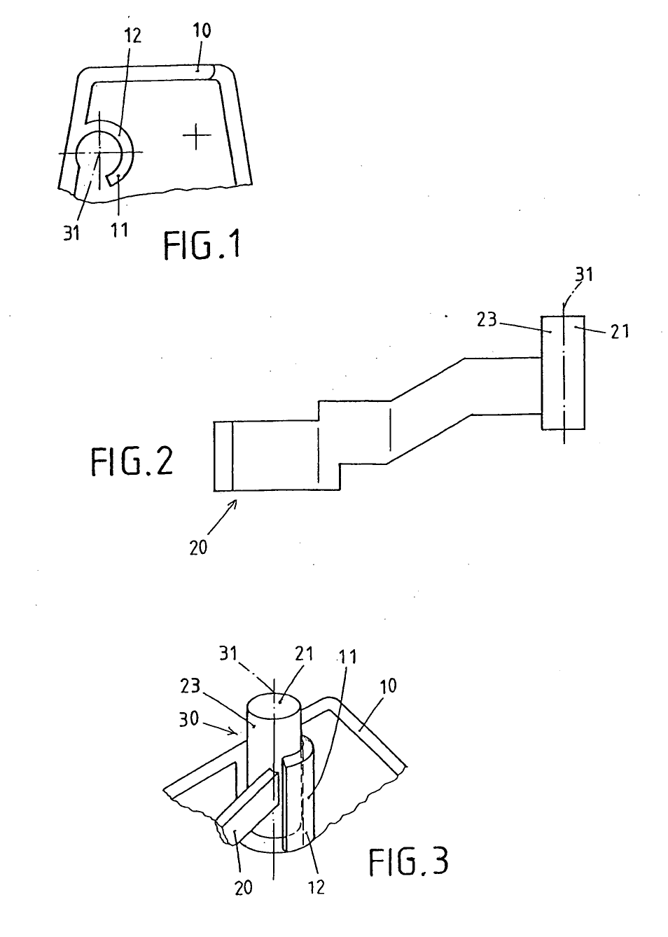

FIG. 1 a top planar view of a housing according to the invention,

FIG. 2 an example according to the invention of a lever in a side elevational view,

FIG. 3 housing and lever from FIGS. 1 and 2 in an assembled state,

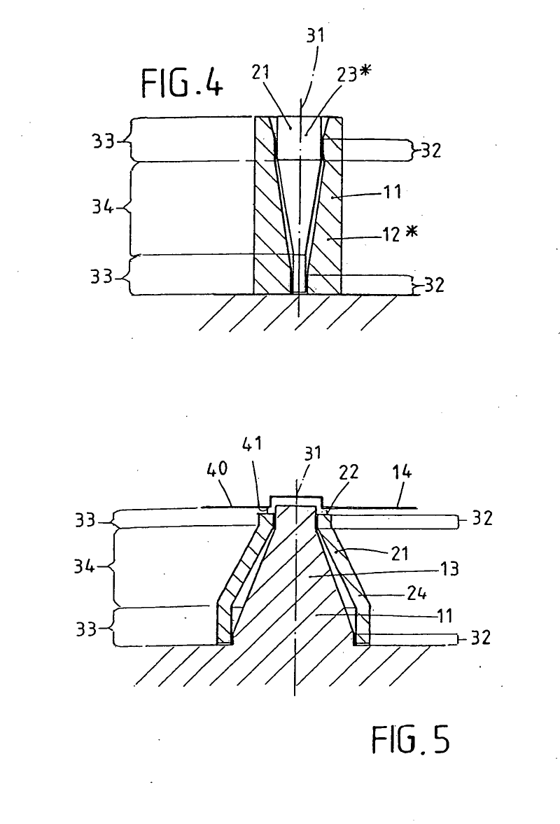

FIG. 4 a further embodiment form of the bearing elements according to the present invention,

FIG. 5 a third embodiment form of the bearing elements according to the present invention,

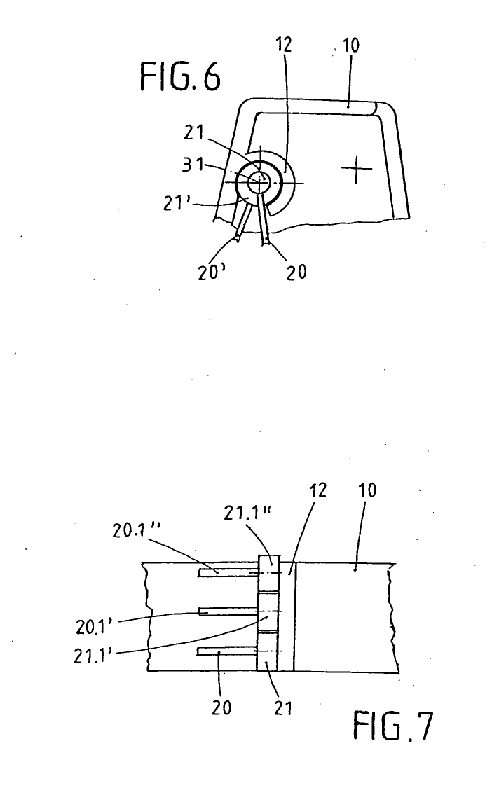

FIG. 6 a further embodiment form of the invention with several levers,

FIG. 7 still another embodiment form of the invention with several levers.

FIG. 1 shows a housing 10 with the second bearing element 11 according to the present invention. This bearing element 11 is here formed as a bearing shell 12. In addition, the bearing axis 31 can be recognized. An embodiment example of a lever 20 according to the invention with a first bearing element 21 is illustrated in FIG. 2. The first bearing element 21 is furnished here as a bearing pin 23. The housing 10 and the lever 20 from the FIGS. 1 and 2 in a composed assembled state are shown in FIG. 3. One can here recognize that the first bearing element 21 is in active connection with the second bearing element 11 and forms in this manner the bearing support 30. The first bearing element 21 is formed here as a bearing pin 23, the second bearing element 11 is formed as a bearing shell 12. The bearing shell 12 grips around the bearing pin 23 over certain regions. Both the bearing pin 23 as well as also the bearing shell 12 are here formed completely cylindrical. A further embodiment example of the invention device shows FIG. 4. The first bearing element 21 is here again also performed as a bearing pin 23*, whereas the second bearing element 11 forms a bearing shell 12*. The first 21 as well as also the second 11 bearing elements have available cylindrical 33 as well as also conical 34 regions. The conical regions 34 are in particular advantageous in the production of the bearing pin 21 (translator's remark: should be 23) through plastic injection molding or zinc die casting method, since therewith drawer bevels are formed, which serve for a better removability of the workpiece from the tool. In the present embodiment example the two bearing elements 21, 11 have two bearing regions 32 in order to enable a particular good and stable support. The bearing regions 32 are arranged here in the cylindrical regions 33 of the first 21 or, respectively, second bearing element 11. It is of course also possible to furnish the bearing elements only conical 34 or, respectively, only one or also more than two bearing regions 32.

Quasi a kinematical reversal of the embodiment form from FIG. 4 is shown in FIG. 5. The first bearing element 21 is formed here as a bearing ring 24. This bearing ring 24 can exhibit a closed or also an open ring shape. The bearing ring 24 comprises the bearing cam 13, which forms the second bearing element 11, at least over certain regions. Here again the two bearing elements 21, 11 exhibit also similar shaped 33 and conical 34 regions, wherein two bearing regions 32 are formed at the cylindrical regions 33.

Furthermore here the securing member 40 can be recognized in the shape of the housing cover 14. The securing member 40 takes care of that the bearing ring 24 is not shiftable upwardly in the direction of the bearing axis 31. In addition the limit stops 41 at the securing member 40, which limit stops 41 cooperate with counter limit stops 22 at the bearing ring 24 in order to limit the shiftability of the first bearing element 21. Of course this can also be realized through projections at the securing member 40 and counter projections at the bearing support 30 at one or several of the bearing elements 21, 11 or at the housing 10.

The FIGS. 6 and 7 now show application examples, wherein several levers 20, 20′, 20.1′, 20.1″ are supported at the same bearing axis 31. Of course, it is also possible to furnish several bearing axes 31 in one housing 10 in order to support different levers 20 there.

FIG. 6 shows a possibility to support the levers 20 and 20′ at the bearing axis 31, wherein the first bearing elements 21, 21′ of the levers 20, 20′ are disposed concentrically around the bearing axle 31. The first bearing elements 21, 21′ are encompassed by the second bearing element 11 formed as a bearing shell 12. A further possibility shows FIG. 7. Here the levers 20, 20.1′, 20.1″ are disposed on top of each other in the direction of the bearing axis 31. The first bearing elements 21, 21.1′, and 21.1″ are disposed on top of each other and have also the same bearing axis 31. Also the first bearing elements 21, 21.1′, and 21.1″ are encompassed over certain regions by the second bearing element 11 formed as a bearing shell 12.

Finally, it is to be pointed out that the here presented embodiment forms are only presentations by way of example of the present invention. The present invention is not limited by the presentations. Instead various changes and modifications are possible.

### LIST OF REFERENCE CHARACTERS

10 housing
11 second bearing element
12 bearing shell in FIG. 1, 3
12* bearing shell in FIG. 4
13 bearing cam
14 housing cover
20 lever
20′ second lever in FIG. 6
20.1″ second lever in FIG. 7
20.1″ third lever in FIG. 7
21 first bearing element
21′ bearing element of 20
21.1′ bearing element of 20.1′ (FIG. 7)
21.1″ bearing element of 20.1″ (FIG. 7)
22 counter limit stop
23 bearing pin in FIG. 2, 3
23* bearing pin in FIG. 4
24 bearing ring
30 bearing support
31 bearing axis
32 support region
33 cylindrical region
34 conical region
40 securing member
41 limit stop

1. Device for supporting of at least one lever (20), with a housing (10), wherein the lever (20) is receivable in the housing (10) at least over certain regions and with a bearing support (30), wherein the bearing support (30) comprises a bearing axis (31), wherein the lever (20) is pivotally supported around the bearing axis (31), wherein the bearing support (30) comprises two bearing elements (21, 11), that is a first bearing element (21), which is fixed against rotation connected to the lever (20) and a second bearing element (11), which is fixed against rotation disposed at the housing (10)
characterized in that
the second bearing element (11) together with the housing (10) is formed as a single piece,
that a securing member (40) is furnished which secures the two bearing elements (21, 11) in their assembled position and
that the two bearing elements (21, 11), are held at each other by pure shape matching under consideration of the securing member (40), and wherein the bearing elements (21, 11) exhibit conical regions (34).

2. Device according to claim 1, characterized in that the housing (10) exhibits a cover (14), wherein the cover (14) serves simultaneously as a securing member (40).

3. Device according to claim 1, characterized in that the securing member (40) can be brought into an action connection with the bearing support (30) or, respectively, with one or several of the bearing elements (21, 11) or with the housing (10), such as by plugging, clipping, screwing, clamping, riveting, welding, adhesively attaching, or snapping.

4. Device according to claim 1, characterized in that limit stops (41) and/or projections are disposed at the securing member, while counter limit stops (22) or, respectively, counter projections are furnished at the bearing support (30) or, respectively, at the bearing elements (21, 11) or at the housing (10), which can be brought together in action connection.

5. Device according to claim 1, characterized in that a bearing pin (23, 23*) serves as a first bearing element (21), while the second bearing element (11) is formed as a bearing shell (12, 12*), which can receive the bearing pin (23, 23*).

6. Device according to claim 1, characterized in that the bearing ring (24) serves as a first bearing element (21), while the second bearing element (11) is formed as a bearing cam (13), wherein the bearing cam (13) is wholly or in part encompassed by the bearing ring (24).

7. Device according to one claim 1, characterized in that the bearing elements (21, 11) exhibit also cylindrical regions (33).

8. Device according to claim 1, characterized in that the two bearing elements (21, 11) form several support regions (32).

9. Device according to claim 7, characterized in that the two bearing elements (21, 11) exhibit both cylindrical shaped (33) regions as well as also conical regions (34), wherein the support region or, respectively, the support regions (32) are disposed in the cylindrical region (33) or, respectively, in the cylindrical regions (33).

10. Device according to claim 1, characterized in that several levers (20, 20′, 20.1′, 20.1″) are supportable at the same bearing axis (31).

11. Device according to claim 10, characterized in that the first bearing elements (21, 21′) of the levers (20, 20′) are disposed concentrically.

12. Device according to, characterized in that the first bearing elements (21, 21.1′, 21.1″) of the lever (20, 20.1, 20.1) are disposed on top of each other relative to the bearing axis (31).

13. Device according to claim 1, characterized in that the housing (10) is furnished as a lock housing, in particular for locks at the doors or flaps for vehicles.

14. Device according to claim 1, characterized in that the lever (20) serves for actuating a switch or key button or for actuating a detent pawl of a lock.

15. Device according to claim 1, characterized in that the housing (10) and/or the lever (20) and/or one or both of the bearing elements (21, 11) consists of metal and that they in particular can be produced by a zinc die cutting method.

16. Device according to claim 1, characterized in that the housing (10) and/or the lever (20) and/or one or both of the bearing elements (21, 11) consists of plastic and that in particular they can be produced by a plastic injection molding method.
